(19) United States
(12) Patent Application Publication
(10) Pub. No.: US 2026/0091943 A1
(43) Pub. Date: Apr. 2, 2026

(54) WORK APPARATUS AND CARRY-IN/OUT APPARATUS

(71) Applicant: HIRATA CORPORATION, Kumamoto-shi (JP)

(72) Inventors: Yasuaki KUROKI, Kumamoto-shi (JP); Yasuaki ODA, Kumamoto-shi (JP); Takuya TOJO, Kumamoto-shi (JP)

(73) Assignee: HIRATA CORPORATION, Kumamoto-shi (JP)

(21) Appl. No.: 19/333,569

(22) Filed: Sep. 19, 2025

(30) Foreign Application Priority Data
Sep. 27, 2024 (JP) 2024-169153

(51) Int. Cl. B65G 49/06

(52) U.S. Cl. CPC B65G 49/061; B65G 49/067

(57) ABSTRACT

A work apparatus comprises a carry-in/out mechanism and a moving mechanism for moving the carry-in/out mechanism, wherein the carry-in/out mechanism includes a substrate support member for supporting a substrate, an advancement/retraction mechanism for advancing/retracting the substrate support member, a substrate conveyance mechanism for conveying the substrate, and a lifting/lowering mechanism for lifting/lowering the substrate conveyance mechanism, the advancement/retraction mechanism includes a base end portion support member for supporting a base end portion of the substrate support member, and a drive portion for moving the base end portion support member, the base end portion is provided at an end portion of the substrate support member, and the lifting/lowering mechanism lifts/lowers the substrate conveyance mechanism and the substrate is transferred between the substrate support member and the substrate conveyance mechanism.

### CROSS-REFERENCE TO RELATED APPLICATION(S)

This application claims priority to and the benefit of Japanese Patent Application No. 2024-169153, filed Sep. 27, 2024, the entire disclosure of which is incorporated herein by reference.

### BACKGROUND OF THE INVENTION

### Field of the Invention

The present invention relates to a work apparatus and a carry-in/out apparatus.

### Description of the Related Art

Chinese Patent Laid-Open No. 115285894 describes a conveyance mechanism capable of conveying a conveyance target in a desired direction. In the mechanism, a fork front-back moving mechanism (3) is arranged on a carrier plate front-back conveyance mechanism (4), a fork lifting/lowering mechanism (2) dedicated to a fork is arranged on the fork front-back moving mechanism, and a fork assembly (1) supporting the conveyance target by a plurality of rod-shaped support members is arranged on such a fork lifting/lowering mechanism.

In general, the conveyance mechanism carries in a conveyance object from a predetermined position and carries out the conveyance object to a different predetermined position (hereinafter referred to as “carry-in/out work”). According to the structure of Chinese Patent Laid-Open No. 115285894, the conveyance mechanism can perform a carry-in/out work selectively with a fork or a conveyor, and can also transfer the conveyance object between the fork and the conveyor by lifting/lowering only the fork. Here, in the structure of Chinese Patent Laid-Open No. 115285894, a plurality of rod-shaped forks and a fork lifting/lowering mechanism which lifts/lowers the forks are advanced/retracted forth and back by the fork front-back moving mechanism. Therefore, a tip side of the rod-shaped fork is easily bent, and an error occurs in a stop position of the lifted fork. In addition, a vibration generated when the fork is lifted and stopped (particularly, a vibration of a tip of the fork in a state where the conveyance object is supported) is likely to increase, the next carry-in/out work cannot be performed until a magnitude of the vibration falls within a predetermined range, and an efficiency of the carry-in/out work may be reduced.

### SUMMARY OF THE INVENTION

An illustrative object of the present invention is to improve an efficiency of a carry-in/out work.

One of the aspects of the present invention provides a work apparatus comprising: a carry-in/out mechanism for performing carry-in/out of a substrate; and a moving mechanism for moving the carry-in/out mechanism, wherein the carry-in/out mechanism includes a substrate support member which extends in a carry-in/out direction so as to be able to support the substrate, an advancement/retraction mechanism configured to advance/retract the substrate support member in the carry-in/out direction, a substrate conveyance mechanism capable of conveying the substrate in the carry-in/out direction, and a lifting/lowering mechanism configured to lift/lower the substrate conveyance mechanism, the advancement/retraction mechanism includes a base end portion support member configured to support a base end portion of the substrate support member, and a drive portion configured to move the base end portion support member in the carry-in/out direction, the base end portion is provided at an end portion on one side in the carry-in/out direction of the substrate support member, and the substrate is transferred between the substrate support member and the substrate conveyance mechanism by the lifting/lowering mechanism lifting/lowering the substrate conveyance mechanism.

Further features of the present invention will become apparent from the following description of exemplary embodiments with reference to the attached drawings.

### BRIEF DESCRIPTION OF THE DRAWINGS

FIG. 1 is a perspective view illustrating an example of an appearance of a work apparatus according to an embodiment;

FIG. 2 is a perspective view illustrating an example of an internal structure of a storage container supply mechanism;

FIG. 3 is a side view of a part of a structure of the storage container supply mechanism in a transparent view;

FIG. 4 is a perspective view illustrating an example of a structure of a storage container;

FIGS. 5A and 5B are perspective views illustrating an example of the internal structure of the storage container supply mechanism;

FIGS. 6A to 6G are schematic side views for explaining an opening/closing operation of the storage container;

FIG. 7 is a perspective view illustrating an example of a structure of a conveyance work unit;

FIG. 8 is a perspective view illustrating an example of an internal structure of a support base which supports a carry-in/out mechanism;

FIG. 9 is a perspective view in which a part of FIG. 8 is not illustrated and the carry-in/out mechanism is included;

FIGS. 10A and 10B are perspective views illustrating an example of a drive mode of the carry-in/out mechanism;

FIG. 11 is a perspective view illustrating an example of a detailed structure of the carry-in/out mechanism;

FIG. 12 is a side view illustrating the example of the detailed structure of the carry-in/out mechanism;

FIGS. 13A to 13D are schematic top views illustrating some examples of modes of carry-in/out or conveyance of a substrate;

FIG. 14 is a perspective view illustrating another example of the structure of the conveyance work unit;

FIG. 15 is a perspective view illustrating an example of the detailed structure of the carry-in/out mechanism;

FIG. 16 is a perspective view illustrating a detailed structure of a fork advancement/retraction mechanism; and

FIGS. 17A and 17B are side views showing a detailed structure of a conveyor lifting/lowering mechanism.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

### Example of Overall Configuration of Work Apparatus

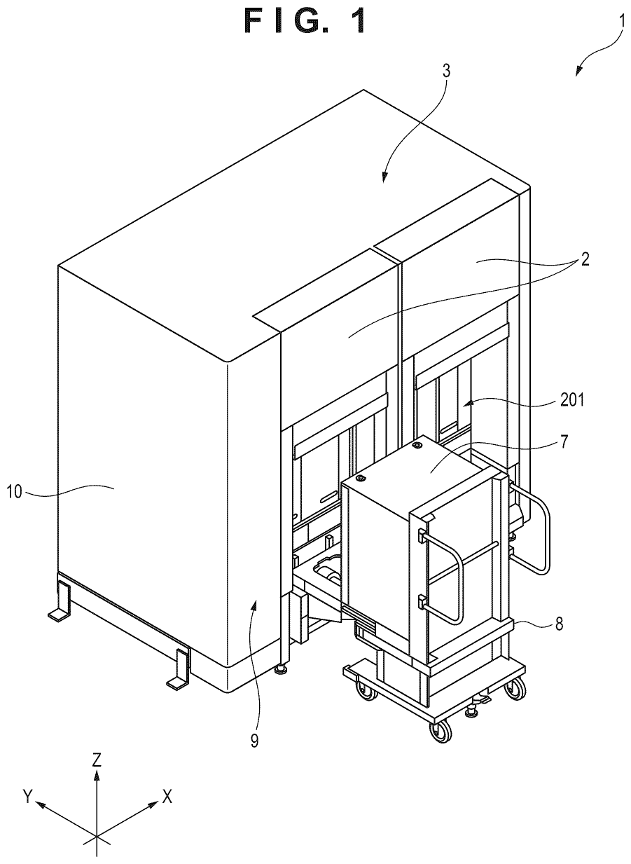

FIG. 1 is a perspective view illustrating an appearance of a work apparatus 1 according to a first embodiment. The work apparatus 1 is configured to be capable of executing a predetermined work on a workpiece to be worked, and in the present embodiment, the work apparatus 1 includes a storage container supply mechanism 2, a conveyance work unit 3, a control unit 9, and an exterior panel 10.

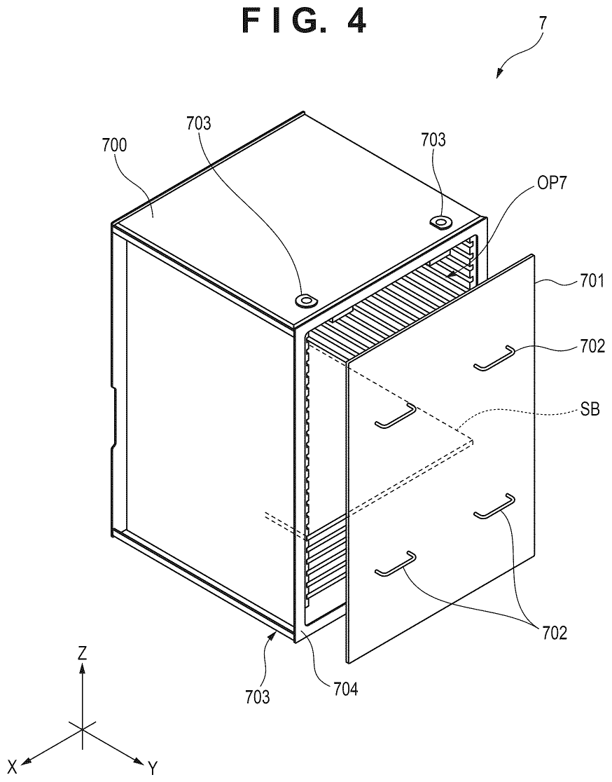

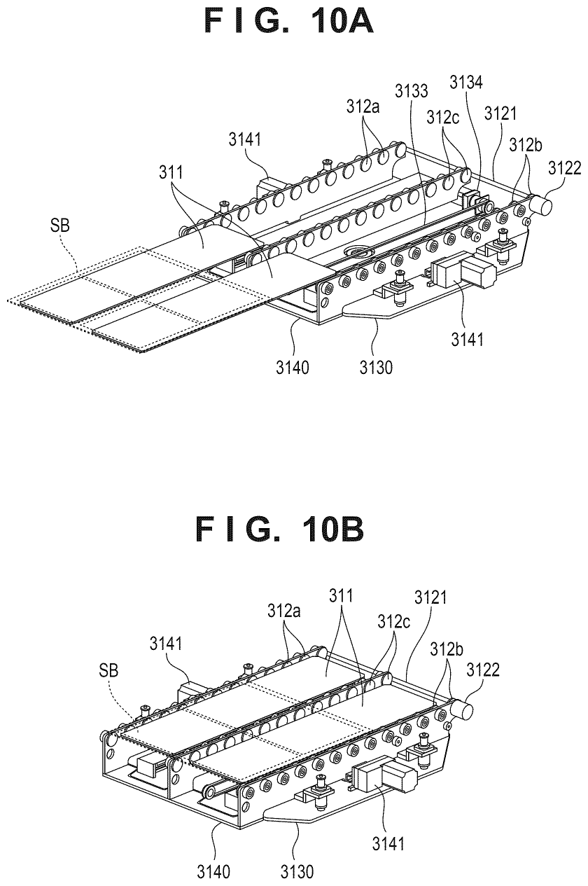

In the present embodiment, the workpiece to be worked is a substrate (a substrate SB in FIGS. 4, 10A, and 10B or the like) such as a glass substrate, a mounting substrate, or a semiconductor substrate, is stored in a predetermined storage container 7, and can be carried in/out between the storage container 7 and the work apparatus 1. In the present specification, transfer into the work apparatus 1 is referred to as carry-in, and transfer out of the work apparatus 1 is referred to as carry-out.

Here, although the same applies to other drawings to be described later, in order to facilitate understanding of the structure, a right-left direction or a width direction of the work apparatus 1 is illustrated as an X direction, a front-back direction or a depth direction is illustrated as a Y direction, and an up-down direction or a height direction is illustrated as a Z direction. The X, Y, and Z directions cross each other (substantially orthogonal), and the X and Y directions form a horizontal plane.

In the present specification, a relative positional relationship between elements can be described on the basis of the X, Y, and Z directions. One direction, which is an arbitrary direction, can be expressed by “+”, and the opposite direction can be expressed by “−”.

For example, a −X direction corresponds to a left direction, a +X direction corresponds to a right direction, and in a case where any one of the right and left directions is not distinguished, it is simply expressed as the X direction. As an example, movement in the X direction indicates that movement (reciprocation) is possible in both the +X direction and the −X direction.

Similarly, a −Y direction side (or −Y side) corresponds to a front side or a near side, a +Y direction side (or a +Y side) corresponds to a back side or a far side, and in a case where any one of the front and back directions is not distinguished, it is simply expressed as the Y direction. As an example, being located on the front side with respect to a predetermined element indicates being located on the −Y direction side.

Similarly, a −Z direction corresponds to a downward direction, a +Z direction corresponds to an upward direction, and when any one of the up and down directions is not distinguished, it is simply expressed as the Z direction. As an example, being located above a predetermined element indicates being located on the +Z direction side (or +Z side).

Although details will be described later, the storage container 7 is configured to be able to store one or more substrates SB, and a user can transport the storage container 7 to the front of the work apparatus 1 using, for example, a cart 8. The storage container supply mechanism 2 enables a carry-in/out work of the substrate SB with respect to such a storage container 7 via a carry-in/out port 201 formed in a housing thereof.

The conveyance work unit 3 transports the substrate SB. For example, the conveyance work unit 3 conveys the substrate SB taken out from or carried in the storage container 7, and transfers (transports) the substrate SB to another subsequent work unit. In addition, the conveyance work unit 3 can also convey the substrate SB received from the other work unit and store or carry out the substrate SB in or from the storage container 7. The other work unit can perform a predetermined work on the substrate SB, and examples of content of the work include a processing work performed on the substrate, such as heating treatment, cleaning treatment, polishing treatment, and injection treatment.

The control unit 9 controls the entire system of the work apparatus 1 and controls driving of the storage container supply mechanism 2 and the conveyance work unit 3. In the present embodiment, the control unit 9 is arranged on the left side of the front side of the work apparatus 1 together with an operation input unit (for example, a touch panel display). The user can input setting information regarding the work content via the operation input unit, and the control unit 9 performs drive control of the storage container supply mechanism 2 and the conveyance work unit 3 on the basis of the setting information.

In the present embodiment, the control unit 9 includes a central processing unit (CPU) and a memory, and causes the CPU and the memory to execute a program for performing drive control of the storage container supply mechanism 2 and the conveyance work unit 3. As another embodiment, the control unit 9 may be configured by a semiconductor apparatus such as an application specific integrated circuit (ASIC). That is, each function of the work apparatus 1 may be realized by either hardware or software.

The exterior panel 10 forms an outer wall of the work apparatus 1, and partitions, as a work chamber, an area including a space into which the substrate SB is carried, from an external space. Together with an additional frame member forming a frame of the work apparatus 1, the exterior panel 10 may be expressed as an apparatus housing. A part of the elements of the storage container supply mechanism 2 and the control unit 9 forms a part of the outer wall of the work apparatus 1, or is attached to the exterior panel 10.

Note that in the present embodiment, a mode in which two storage container supply mechanisms 2 are arranged side by side in the X direction is illustrated, but the number of the storage container supply mechanisms 2 is not limited to this example, and a single storage container supply mechanism 2 may be arranged, or three or more storage container supply mechanisms 2 may be arranged.

### Example of Configuration of Carry-in/out Work Unit

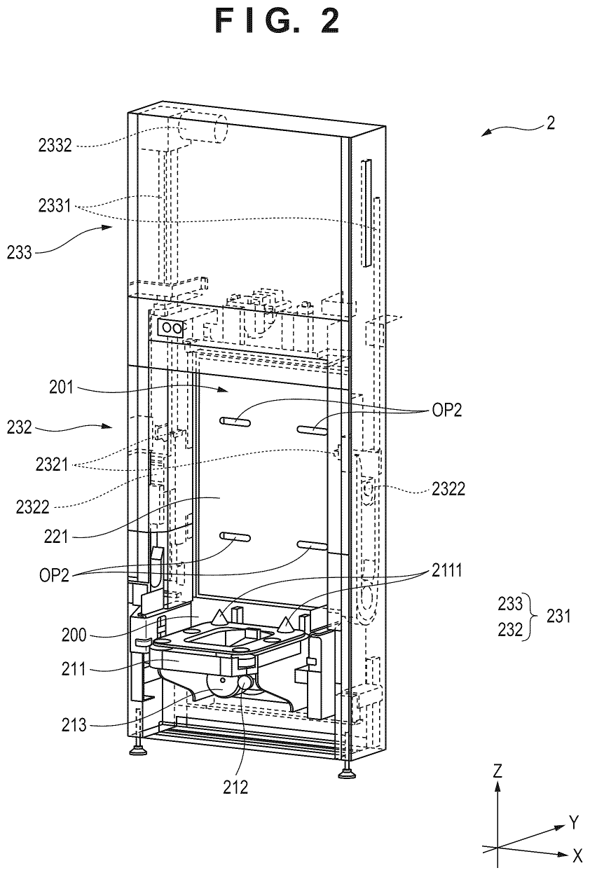

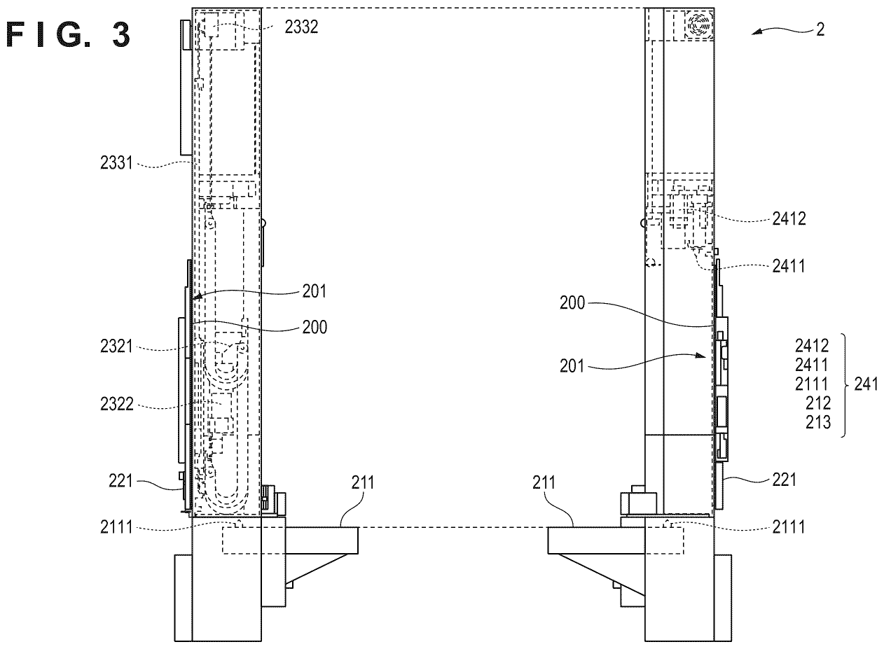

FIG. 2 is a perspective view illustrating an internal structure of the storage container supply mechanism 2. FIG. 3 is a schematic left side view and a schematic right side view of a part of the structure of the storage container supply mechanism 2 in a transparent view. The carry-in/out port 201 leading to the work chamber is provided in a front-side central portion of a wall member 200 constituting the housing of the storage container supply mechanism 2, and carry-in/out of the substrate SB is performed via the carry-in/out port 201 although details will be described later.

The storage container supply mechanism 2 includes a storage container support base 211, a support base lifting/lowering mechanism 213, and a support base advancement/retraction mechanism 212 below the carry-in/out port 201. The storage container support base 211 is configured to be able to support the storage container 7, and the upper surface of the storage container support base 211 allows the storage container 7 to be placed thereon and is also provided with a lower positioning portion 2111 to be described later. The support base lifting/lowering mechanism 213 can move the storage container support base 211 in the Z direction, and lifts the storage container support base 211 to engage the lower positioning portion 2111 with an engagement portion 703 on a bottom surface of a container body 700 to be described later, and the storage container support base 211 supports the storage container 7. In addition, the support base advancement/retraction mechanism 212 can move the storage container support base 211 in the Y direction, so that the storage container support base 211 and the storage container 7 thereon can be advanced/retracted. That is, in a state of being supported by the storage container support base 211, the storage container 7 can be lifted/lowered by the support base lifting/lowering mechanism 213 and can be advanced/retracted by the support base advancement/retraction mechanism 212.

In addition, the storage container supply mechanism 2 further includes a shielding door 221 and a shielding door moving mechanism 231.

The shielding door 221 shields the carry-in/out port 201 formed in the wall member 200 from the inside of the work chamber. As will be described in detail later, the shielding door 221 is separated from the carry-in/out port 201 to release the shielding, and the carry-in/out port 201 is opened to be in an open state as the shielding door 221 moves upward. In addition, when the shielding door 221 is lowered to a position facing the carry-in/out port 201 and the shielding door 221 approaches the carry-in/out port 201, the carry-in/out port 201 is shielded and the carry-in/out port 201 becomes in a closed state.

Here, it is assumed that the shielding door 221 is in the open state when the carry-in/out port 201 is in the open state, and that the shielding door 221 is in the closed state when the carry-in/out port is in the closed state. In the present embodiment, the shielding door 221 is made of a member larger than the carry-in/out port 201, and shields the carry-in/out port 201 by abutting against the wall member 200 around the carry-in/out port 201 so as to cover the carry-in/out port 201. Here, a seal member which abuts against the shielding door 221 may be provided on the work chamber side of the carry-in/out port 201 or the wall member 200. In addition, the shielding door 221 may be made of a member having approximately the same size as the carry-in/out port 201, and the shielding door 221 may be fitted to the carry-in/out port 201 to shield the carry-in/out port 201. In this case, the seal member may be provided at an edge portion of the carry-in/out port 201.

The shielding door moving mechanism 231 is configured to be movable so that the shielding door 221 changes from one of the open state and the closed state to the other, and includes a shielding door retracting mechanism 232 and a shielding door lifting/lowering mechanism 233 in the present embodiment.

The shielding door retracting mechanism 232 includes a guide member 2321 and a drive portion 2322 (first moving mechanism). The guide member 2321 holds the shielding door 221 and guides the shielding door 221 so as to be movable in the Y direction. In the present embodiment, the guide member 2321 is a guide rail extending in the Y direction. The drive portion 2322 includes a power source which generates power and a drive mechanism which moves the shielding door 221 in the Y direction by the power of the power source.

The shielding door lifting/lowering mechanism 233 includes a guide member 2331 and a drive portion 2332 (second moving mechanism). The guide member 2331 holds the shielding door 221 and the shielding door retracting mechanism 232 and guides the shielding door 221 and the shielding door retracting mechanism 232 so as to be movable in the Z direction. In the present embodiment, the guide member 2331 is a guide rail extending in the Z direction. The drive portion 2332 includes a power source which generates power and a drive mechanism which moves the shielding door 221 and the shielding door retracting mechanism 232 in the Z direction by the power of the power source.

For example, in a case where the shielding door 221 is changed from the closed state to the open state, the shielding door retracting mechanism 232 moves and retracts the shielding door 221 in the +Y direction, whereby the shielding door 221 and the shielding door retracting mechanism 232 are separated from the carry-in/out port 201, and the shielding door lifting/lowering mechanism 233 moves and lifts the shielding door 221 and the shielding door retracting mechanism 232 in the +Z direction. On the other hand, in a case where the shielding door 221 is changed from the open state to the closed state, the shielding door lifting/lowering mechanism 233 moves and lowers the shielding door 221 and the shielding door retracting mechanism 232 in the −Z direction, and the shielding door retracting mechanism 232 moves the lowered shielding door 221 in the −Y direction to shield the carry-in/out port 201.

The shielding door moving mechanism 231 may be expressed as a shielding door opening/closing mechanism.

The shielding door retracting mechanism 232 and the shielding door lifting/lowering mechanism 233 can be arranged at least partially on the side of the carry-in/out port 201 and outside the wall member 200 (−Y direction). In the present embodiment, the guide members 2321 and 2331 and the drive portion 2322 are provided outside the wall member 200 (−Y direction) and on one side (+X direction) and the other side (−X direction) of the carry-in/out port 201, respectively, and the drive portion 2332 is provided outside the wall member 200 (−Y direction) and on the other side (−X direction) of the carry-in/out port 201. Accordingly, it is possible to sufficiently secure the area of the work chamber by reducing the number of components of the shielding door retracting mechanism 232 and the shielding door lifting/lowering mechanism 233 located in the work chamber, and to reduce the influence on the conveyance work of the substrate SB in the work chamber to be described later.

### Example of Configuration of Storage Container

FIG. 4 is a perspective view illustrating a structure of the storage container 7. The storage container 7 includes the container body 700 and a lid portion 701.

An opening OP7 is provided on a side surface of the container body 700, and one or more substrates SB are supported in a horizontal posture along a support member provided on an inner wall of the container body 700, and can be individually inserted into and removed from the opening OP7 in a horizontal direction.

The lid portion 701 is detachably attached to the container body 700 so as to close the opening OP7. In the present embodiment, both an edge portion 704 around the opening OP7 of the container body 700 and the lid portion 701 are detachable by a pin and a pin hole (not illustrated) and/or a magnet. With such a configuration, the lid portion 701 can be detached by applying a force in a direction away from the container body 700 (+Y direction in the drawing).

Although details will be described later, a protruding portion 702 protruding or extending in the horizontal direction is provided on an outer surface (a surface on the +Y side in the drawing) of the lid portion 701. In the present embodiment, the protruding portion 702 has a shape including a bar portion extending in a bar shape and leg portions having both end portions connected to the lid portion 701, and for convenience, this shape is a horizontal U shape. One or more protruding portions 702 may be provided, but a plurality of protruding portions 702 (four protruding portions in the present embodiment) may be provided. In addition, the protruding portion 702 may be expressed as an extending portion.

In addition, although details will be described later, the engagement portion 703 is provided in each of the upper portion and the lower portion of the container body 700. In the present embodiment, the engagement portion 703 is provided on each of the upper surface and the bottom surface of the container body 700.

Here, referring again to FIG. 3, the storage container supply mechanism 2 further includes an upper positioning portion 2411 and an upper positioning portion moving mechanism 2412 above the carry-in/out port 201. The upper positioning portion moving mechanism 2412 enables the upper positioning portion 2411 to move in the Z direction by a known configuration.

With such a configuration, the upper positioning portion 2411 can be engaged with the engagement portion 703 on the upper surface of the container body 700, and the lower positioning portion 2111 can be engaged with the engagement portion 703 on the bottom surface of the container body 700, whereby the container body 700 can be positioned. That is, the upper positioning portion 2411, the upper positioning portion moving mechanism 2412, the lower positioning portion 2111, the support base advancement/retraction mechanism 212, and the support base lifting/lowering mechanism 213 function as a positioning mechanism 241 which cooperatively positions the container body 700 (storage container 7). Accordingly, the upper surface and the bottom surface of the container body 700 are positioned, and even when there is twisting or warping in the container body 700, it is corrected.

Note that, in the present embodiment, a pair of right and left engagement portions 703 are provided for each of the upper surface and the bottom surface of the container body 700, and the positioning portions 2111 and 2411 are provided corresponding to the pair of right and left engagement portions 703, but the number thereof is not limited to this example.

### Example of Configuration of Shielding Door

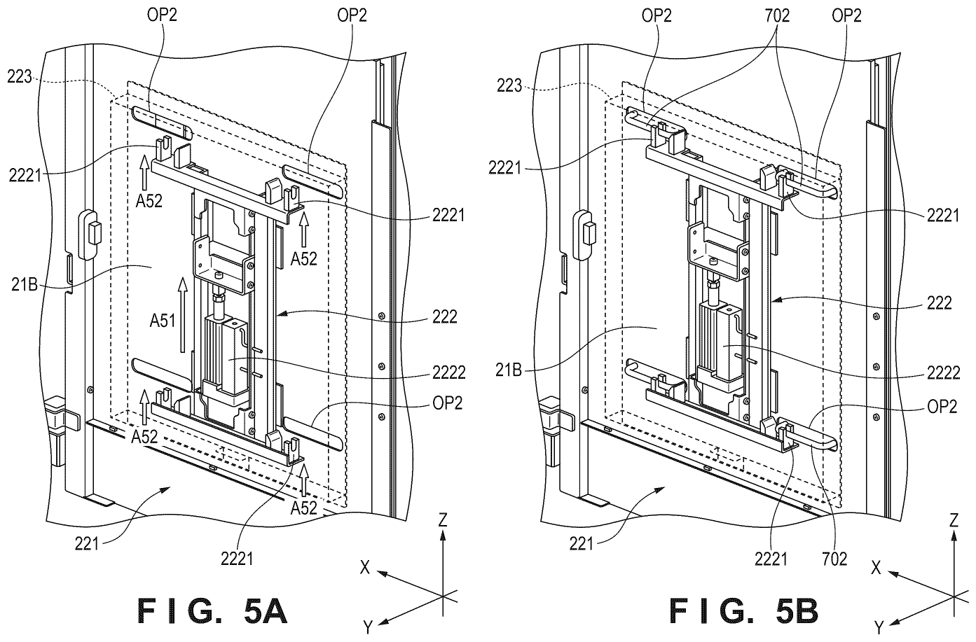

FIGS. 5A and 5B are perspective views illustrating the internal structure of the storage container supply mechanism 2, and illustrate a state where the shielding door 221 is viewed from the work chamber side (the side opposite to the side on which the storage container 7 is arranged). The shielding door 221 includes a door body 221B, a protruding portion holding mechanism 222, and a cover member 223.

In the door body 221B, one or more (four in the present embodiment) hole portions OP2 through which the protruding portions 702 are insertable are provided corresponding to the number and positions of the protruding portions 702.

The protruding portion holding mechanism 222 includes a protruding portion holding portion 2221 and an actuator 2222. One or more (four in the present embodiment) protruding portion holding portions 2221 are provided corresponding to the number of the hole portions OP2. The protruding portion holding mechanism 222 may have a shape engageable with the protruding portion 702 having the above-described horizontal U shape. In the present embodiment, the protruding portion holding mechanism 222 has a U shape with the upper side open, and for convenience, this shape is a vertical U shape.

The individual protruding portion holding portion 2221 is connected to the actuator 2222 via a connection member, and can be lifted/lowered on the basis of power from the actuator 2222. That is, as illustrated in FIG. 5A, in a case where the actuator 2222 moves upward as indicated by an arrow A51, the individual protruding portion holding portions 2221 rise as indicated by an arrow A52.

The cover member 223 is provided on the work chamber side so as to cover the hole portion OP2 and the protruding portion holding mechanism 222, and a wire such as a signal line or a power line connected to the actuator 2222 is inserted through a predetermined opening.

When the protruding portion 702 of the lid portion 701 of the storage container 7 is inserted into the hole portion OP2, the corresponding protruding portion holding portion 2221 moves upward on the basis of the power of the actuator 2222. At this time, the protruding portion holding portion 2221 having a vertical U shape supports the protruding portion 702 having a horizontal U shape from below. With such a configuration, the protruding portion holding mechanism 222 can hold the protruding portion 702 as illustrated in FIG. 5B.

### Opening/Closing Operation of Storage Container for Performing Carry-In/Out

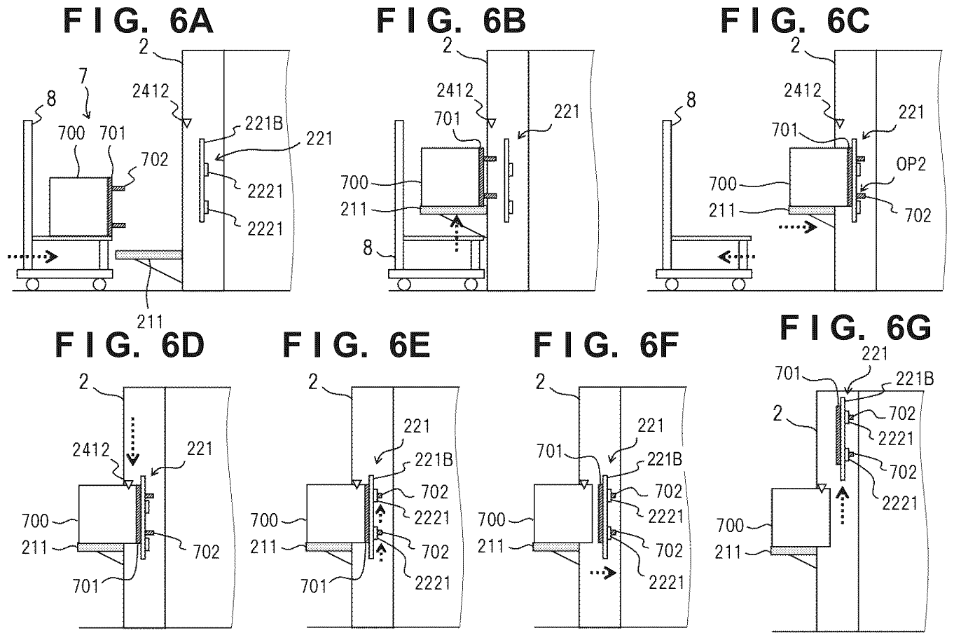

FIGS. 6A to 6G are schematic side views for explaining an opening/closing operation of the storage container 7 for performing carry-in/out according to the present embodiment. Note that in order to facilitate understanding, a broken line arrow indicating a direction of an operation with respect to an element in which the operation occurs is illustrated in the drawing.

First, the user arranges the storage container 7 in front of the storage container supply mechanism 2 by using the cart 8 (see FIG. 6A).

Next, the control unit 9 lifts the storage container support base 211 by the support base lifting/lowering mechanism 213 on the basis of the setting information input by the user, and the storage container support base 211 supports the storage container 7. Accordingly, the storage container 7 is transferred from the cart 8 to the storage container support base 211 (see FIG. 6B). Prior to this, the control unit 9 may advance/retract the storage container support base 211 by the support base advancement/retraction mechanism 212 such that the lower positioning portion 2111 on the upper surface of the storage container support base 211 is engaged with the engagement portion 703 on the bottom surface of the container body 700.

After the storage container support base 211 is lifted until the lower positioning portion 2111 reaches a predetermined height, the control unit 9 advances/retracts the storage container support base 211 by the support base advancement/retraction mechanism 212 to bring the storage container 7 close to the shielding door 221 (see FIG. 6C). Accordingly, the protruding portion 702 of the lid portion 701 is inserted into the hole portion OP2, and the engagement portion 703 on the upper surface of the container body 700 and the upper positioning portion 2411 overlap each other in the Z direction (the engagement portion 703 is located so as to be engageable with the upper positioning portion 2411).

Note that the user can remove the cart 8 from the front of the storage container supply mechanism 2 as necessary.

The control unit 9 further lowers the upper positioning portion 2411 by the upper positioning portion moving mechanism 2412 to be engaged with the engagement portion 703 on the upper surface of the container body 700 (see FIG. 6D). In this manner, the storage container 7 (container body 700) is positioned, and the position of the storage container 7 with respect to the storage container supply mechanism 2 is determined.

Thereafter, the control unit 9 drives the protruding portion holding mechanism 222 of the shielding door 221 to lift the protruding portion holding portion 2221 on the basis of the power of the actuator 2222 and hold the protruding portion 702 inserted into the hole portion OP2 (see FIGS. 6E and 5B).

In this state, the control unit 9 drives the shielding door retracting mechanism 232 to move and retract the shielding door 221 in the +Y direction to be separated from the carry-in/out port 201 (see FIG. 6F). Accordingly, the lid portion 701 is detached from the container body 700.

Then, the control unit 9 drives the shielding door lifting/lowering mechanism 233 to move and lift, in the +Z direction, the shielding door 221 retracted to be separated from the carry-in/out port 201 (see FIG. 6G). Accordingly, the lid portion 701 in which the protruding portion 702 is held by the protruding portion holding mechanism 222 of the shielding door 221 moves upward together with the shielding door 221.

In this manner, the storage container supply mechanism 2 opens the storage container 7, and causes the opening OP7 and the carry-in/out port 201 to communicate with each other. Accordingly, the substrate SB can be brought into a state that allows carry-in/out. In a case where the storage container 7 is in the closed state, the above procedure can be performed in a reverse order.

In addition, in the present embodiment, the opening/closing of the carry-in/out port 201, the opening/closing of the shielding door 221, the opening/closing of the storage container 7, the opening/closing of the opening OP7, and the opening/closing of the lid portion 701 correspond to each other. For example, bringing the carry-in/out port 201 into the open state may be paraphrased as bringing the shielding door 221, the storage container 7, the opening OP7, or the lid portion 701 into the open state.

Note that the cart 8 may be configured to be able to transfer the storage container 7 to the storage container support base 211 by lifting the storage container support base 211 and receive the storage container 7 from the storage container support base 211 by lowering the storage container support base 211.

In addition, in the present embodiment, the user conveys the storage container 7 by the cart 8, but the present invention is not limited thereto, and for example, the storage container 7 may be conveyed by an automatic guided vehicle (AGV), an autonomous mobile robot (AMR), or the like.

According to such a configuration, when the carry-in/out port 201 and the opening OP7 are brought into the open state to allow the substrate SB to be carried in/out, the container body 700 can be kept close to the carry-in/out port 201, whereby mixing of foreign matter into the inside of the container body 700 and the work chamber of the work apparatus 1 is prevented, which is advantageous for improving the quality of the product. In addition, there is no need for the user to advance/retract the container body 700 at the time of carrying in/out the substrate SB, and thus, appropriate carry-in/out of the substrate SB can be realized relatively easily. In addition, the same applies when the carry-in/out port 201 and the opening OP7 are brought into the closed state.

### Example of Configuration of Conveyance Work Unit

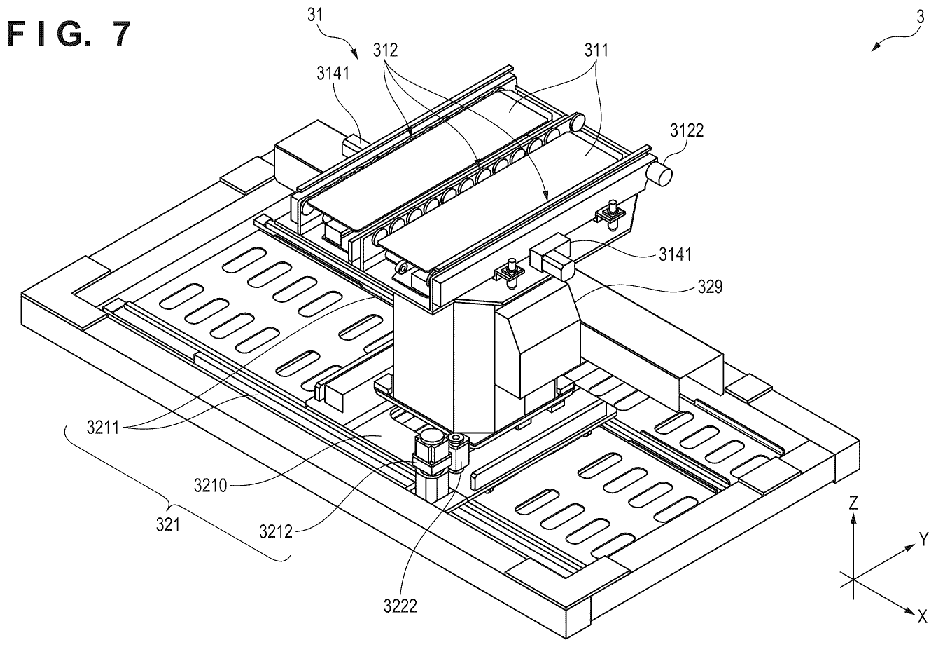

FIG. 7 is a perspective view of the conveyance work unit 3. The conveyance work unit 3 includes a carry-in/out mechanism 31, a right-left moving mechanism 321, and a support base 329.

The carry-in/out mechanism 31 includes a fork 311 and a conveyor 312. The fork 311 is a plate-shaped substrate support member capable of supporting the substrate SB from below, and in the present embodiment, the fork 311 is a pair of plate-shaped members which each extend in one direction and are arranged apart from each other by a predetermined distance.

In addition, the conveyor 312 is a substrate conveyance mechanism capable of conveying the substrate SB. In the present embodiment, the conveyor 312 is a roller conveyor, and has three conveyance roller rows constituted by a plurality of conveyance rollers, and each of the pair of forks 311 is provided between the conveyance roller rows. Further details will be described later.

Here, in the present embodiment, the fork 311 is a plate-shaped member, but may be a rod-shaped member extending in one direction, or three or more forks may be arranged. In addition, the upper surface of the fork 311 may be provided with a plurality of convex support portions which abut against to support the substrate. In addition, the conveyor 312 may be a belt conveyor, and the conveyance work unit 3 may be expressed as the work apparatus.

The support base 329 supports the carry-in/out mechanism 31 so as to be movable in each of the Y and Z directions and to be rotatable about the Z direction as a central axis, which will be described in detail later. The support base 329 may be expressed as a rotation support base.

The right-left moving mechanism 321 supports the support base 329 and the carry-in/out mechanism 31 thereon so as to be movable in the X direction, and includes a support plate member 3210, a pair of guide rails 3211, and a drive portion 3212 in the present embodiment. The support base 329 and various mechanisms to be described later at least partially incorporated in the support base are mounted on the support plate member 3210. The pair of guide rails 3211 are arranged to be separated in the Y direction and extend in the X direction, and support the support plate member 3210 so as to be movable in the X direction.

The drive portion 3212 includes a power source which generates power and a drive mechanism which moves the support plate member 3210 in the X direction by the power of the power source. With such a configuration, the right-left moving mechanism 321 forms a slider capable of moving (reciprocating) in the X direction.

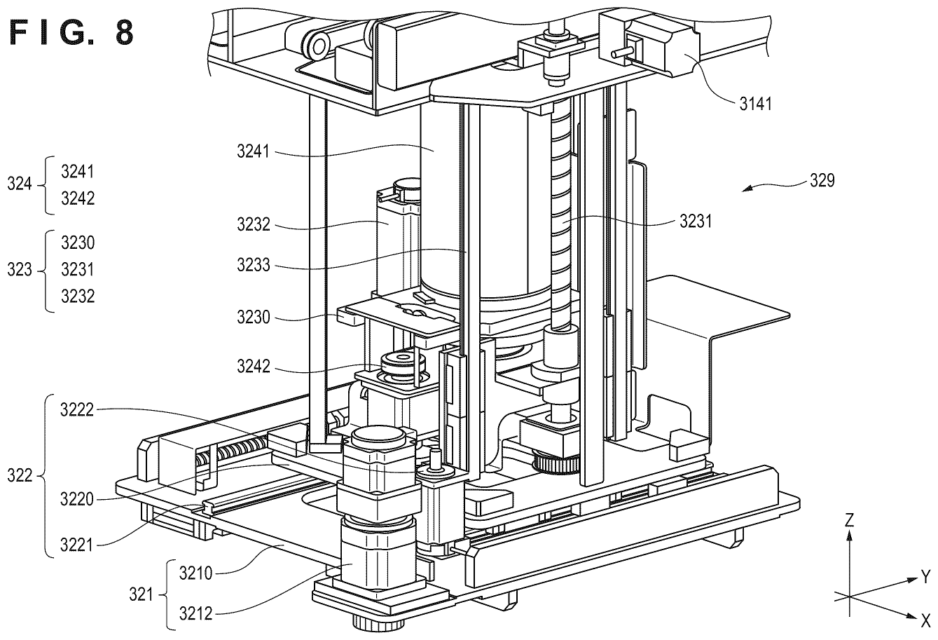

FIG. 8 is a perspective view illustrating an internal structure of the support base 329. The support base 329 at least partially incorporates a front-back moving mechanism 322, an up-down moving mechanism 323, and a rotation mechanism 324.

The front-back moving mechanism 322 includes a support plate member 3220, a pair of guide rails 3221, and a drive portion 3222. The up-down moving mechanism 323 is mounted on the support plate member 3220. The pair of guide rails 3221 are arranged to be separated in the X direction and extend in the Y direction, and support the support plate member 3220 so as to be movable in the Y direction. The drive portion 3222 includes a power source which generates power and a drive mechanism which moves the support plate member 3220 in the Y direction by the power of the power source. With such a configuration, the front-back moving mechanism 322 forms a slider capable of moving (advancing/retracting) in the Y direction.

The up-down moving mechanism 323 includes a support plate member 3230, a ball screw shaft 3231, a power source 3232, and a pair of guide rails 3233. The rotation mechanism 324 is mounted on the support plate member 3230. The ball screw shaft 3231 extends in the Z direction and rotates about the Z direction by the power of the power source 3232. The pair of guide rails 3233 are arranged to be separated in the Y direction and extend in the Z direction, and support the support plate member 3230 so as to be movable in the Z direction. The support plate member 3230 is screwed to the ball screw shaft 3231 extending in the Z direction, and when the ball screw shaft 3231 rotates on the basis of the power of the power source 3232, the support plate member moves in the Z direction along the guide rails 3233 accordingly. With such a configuration, the up-down moving mechanism 323 forms a slider capable of moving (lifting/lowering) in the Z direction.

The rotation mechanism 324 includes a support column 3241 and a drive portion 3242. The support column 3241 is configured to be rotatable about the Z direction as a rotation axis on the basis of the power of the drive portion 3242, and the carry-in/out mechanism 31 is mounted on the support column 3241.

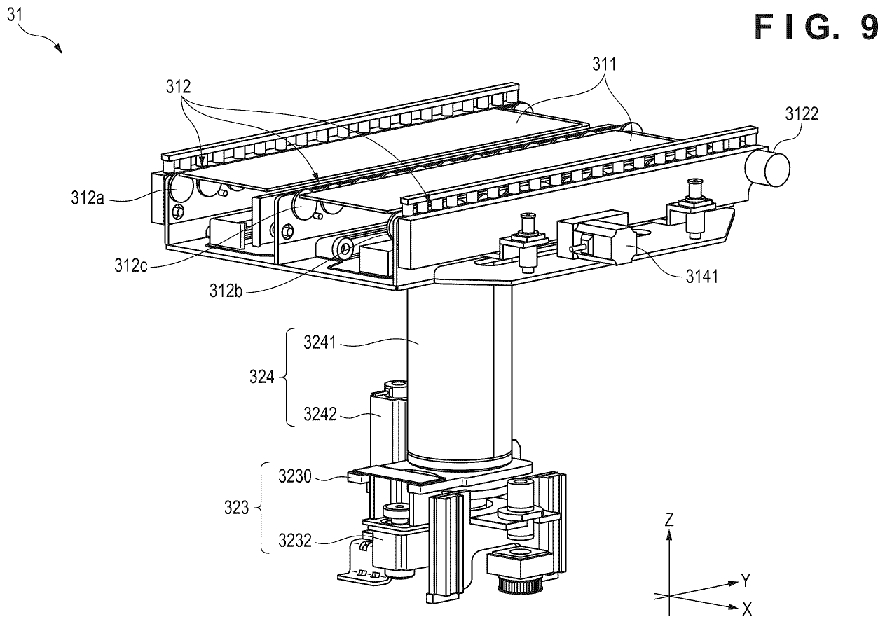

FIG. 9 is a perspective view illustrating an entire structure in which a part of FIG. 8 is not illustrated and the carry-in/out mechanism 31 is included. The carry-in/out mechanism 31 is rotatably supported by the rotation mechanism 324, the rotation mechanism 324 is vertically movably supported by the up-down moving mechanism 323, the up-down moving mechanism 323 is mounted on the front-back moving mechanism 322 so as to be able to advance/retract, and the front-back moving mechanism 322 is mounted on the right-left moving mechanism 321 so as to be able to reciprocate. With such a configuration, the carry-in/out mechanism 31 can move in any of the X, Y, and Z directions, and can change the posture/direction in an arbitrary direction (horizontal direction) on an X-Y plane.

Note that the order of arrangement of the mechanisms 321 to 324 is not limited to this example.

For example, in the present embodiment, the rotation mechanism 324 is mounted on the up-down moving mechanism 323 so as to be able to be lifted/lowered, the up-down moving mechanism 323 is mounted on the front-back moving mechanism 322 so as to be able to advance/retract, and the front-back moving mechanism 322 is mounted on the right-left moving mechanism 321 so as to be able to reciprocate. However, as another embodiment, the rotation mechanism 324 may be mounted on the front-back moving mechanism 322 so as to be able to advance/retract, the front-back moving mechanism 322 may be mounted on the up-down moving mechanism 323 so as to be able to be lifted/lowered, and the up-down moving mechanism 323 may be mounted on the right-left moving mechanism 321 so as to be able to reciprocate.

The right-left moving mechanism 321 may be expressed as a reciprocating mechanism, or may be expressed as a carry-in/out mechanism right-left moving mechanism, a carry-in/out mechanism reciprocating mechanism, or the like in order to be distinguished from another mechanism.

The front-back moving mechanism 322 may be expressed as an advancement/retraction mechanism, or may be expressed as a carry-in/out mechanism front-back moving mechanism, a carry-in/out mechanism advancement/retraction mechanism, or the like in order to be distinguished from another mechanism (note that expressions such as reciprocating and advancing/retracting are used for distinction and are interchangeable with each other).

The up-down moving mechanism 323 may be expressed as a lifting/lowering mechanism, or may be expressed as a carry-in/out mechanism up-down moving mechanism, a carry-in/out mechanism lifting/lowering mechanism, or the like in order to be distinguished from another mechanism.

In addition, the rotation mechanism 324 may be expressed as a posture changing mechanism since it changes the posture/direction of the carry-in/out mechanism 31, or may be expressed as a carry-in/out mechanism rotation mechanism, a carry-in/out mechanism posture changing mechanism, or the like in order to be distinguished from another mechanism.

Any of the above-described operations is included in movement in a broad sense, and the above-described mechanisms 321 to 324 may be simply expressed as a moving mechanism. In this case, expressions such as “first” and “second” may be attached to them for distinction, and for example, the mechanisms 321 to 324 may be expressed as first to fourth moving mechanisms, respectively. Alternatively, the above-described mechanisms 321 to 324 may be expressed as a carry-in/out mechanism moving mechanism in order to be distinguished from another mechanism, and in such a case, expressions such as “first”and “second”may be attached.

FIGS. 10A and 10B are perspective views illustrating a drive mode of the carry-in/out mechanism 31. In the carry-in/out mechanism 31, in the present embodiment, the fork 311 can advance/retract in one direction, FIG. 10A illustrates a state where the fork 311 has advanced, and FIG. 10B illustrates a state where the fork 311 has retracted.

As described above, the conveyor 312 includes three conveyance roller rows, and each of the pair of forks 311 is provided between the conveyance roller rows. In other words, in the conveyor 312, three conveyance roller rows are provided at intervals in a plane direction orthogonal to the conveyance direction, and the fork 311 is provided between each of a plurality of roller rows.

In the present embodiment, a conveyance roller row including a plurality of conveyance rollers 312a, a conveyance roller row including a plurality of conveyance rollers 312c, and a conveyance roller row including a plurality of conveyance rollers 312b are arranged in this order in the plane direction orthogonal to the conveyance direction. One of the pair of forks 311 is arranged between the conveyance roller row including the plurality of conveyance rollers 312a and the conveyance roller row including the plurality of conveyance rollers 312c. The other of the pair of forks 311 is arranged between the conveyance roller row including the plurality of conveyance rollers 312c and the conveyance roller row including the plurality of conveyance rollers 312b. Here, the carry-in/out mechanism 31 may be expressed as a carry-in/out apparatus.

The plurality of conveyance rollers 312a, 312b, and 312 each include a roller portion which supports and conveys the substrate SB and a sprocket portion which rotates integrally with the roller portion. The sprocket portion of each of the plurality of conveyance rollers 312a, 312b, and 312c is connected by a belt (not illustrated) so that the rotation is interlocked.

One conveyance roller of each of the plurality of conveyance rollers 312a, 312b, and 312c is connected by a shaft 3121.

A power source 3122 is connected to the shaft 3121, and the shaft 3121 is rotated by the power of the power source 3122. As the shaft 3121 rotates, one of the conveyance rollers 312a rotates, and another conveyance roller 312a rotates via the belt. The same applies to the conveyance rollers 312b and 312c. The substrate SB is conveyed by the rotation of the conveyance rollers 312a, 312b, and 312c.

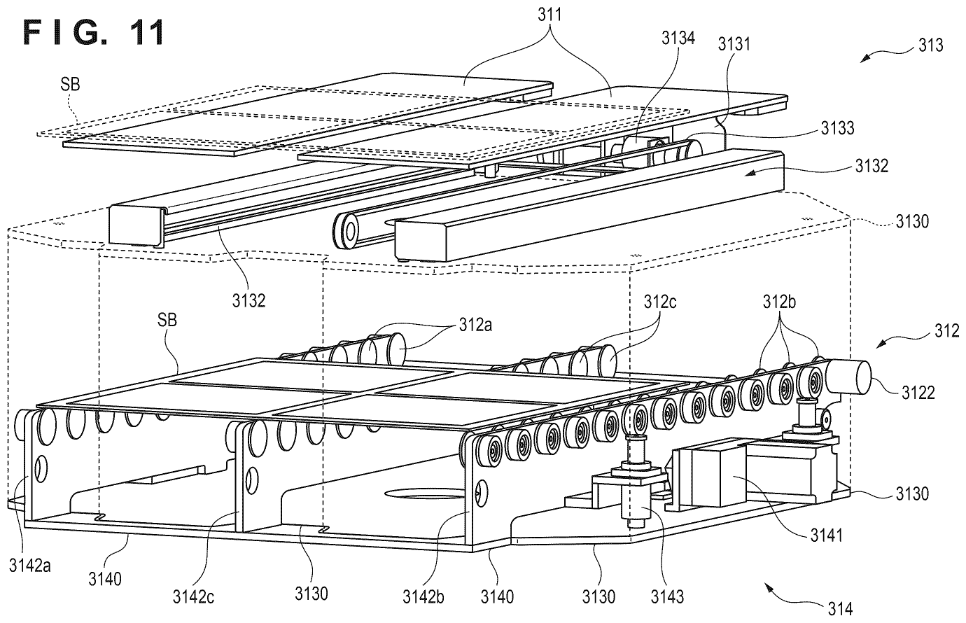

FIG. 11 is a perspective view illustrating a detailed structure of the carry-in/out mechanism 31. The carry-in/out mechanism 31 includes the fork 311 and the conveyor 312, and further includes a support plate member 3130, a fork advancement/retraction mechanism 313, and a conveyor lifting/lowering mechanism 314. The fork advancement/retraction mechanism 313 includes a fork support member 3131, a guide mechanism 3132, a belt 3133, and a power source 3134. The conveyor lifting/lowering mechanism 314 includes a connection plate member 3140, a drive portion 3141, support plate members 3142a to 3142c, and a guide member 3143. The fork advancement/retraction mechanism 313 and the conveyor lifting/lowering mechanism 314 are provided in the support plate member 3130.

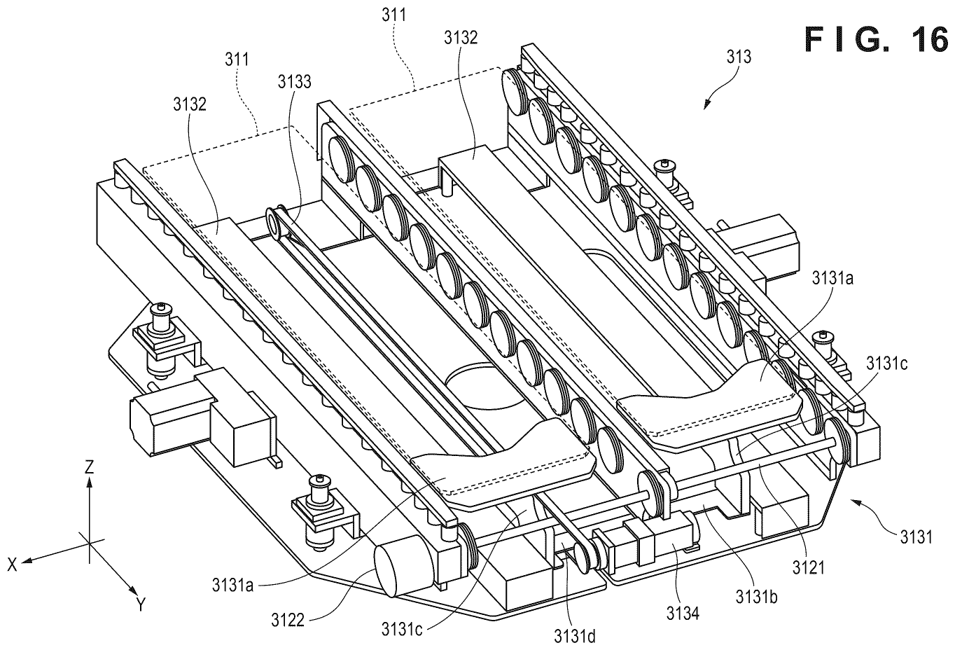

FIG. 16 is a perspective view illustrating a detailed structure of the fork advancement/retraction mechanism 313. Hereinafter, description will be made with reference to FIGS. 11 and 16.

In the present embodiment, a pair of guide mechanisms 3132 are provided on the support plate member 3130 so as to extend in one direction. The belt 3133 is an endless traveling band extending side by side with the guide mechanism 3132 between the pair of guide mechanisms 3132, and is rotatable on the basis of the power of the power source 3134. The fork support member 3131 includes a pair of supporting portions 3131a which support a base end portion (one end portion) of the plate-shaped fork 311 so that the fork 311 is in a horizontal posture, a holding portion 3131b which is held by the guide mechanism 3132 so as to be able to reciprocate along the pair of guide mechanisms 3132, a plate portion 3131c which connects the supporting portion 3131a and the holding portion 3131b, and a connection portion 3131d which is connected to the belt 3133. Therefore, the fork support member 3131 is supported to be able to reciprocate along the guide mechanism 3132, and moves along the guide mechanism 3132 by the rotation of the belt 3133.

Together with the fork support member 3131, the pair of forks 311 also moves along the guide mechanism 3132. Here, since the fork support member 3131 supports the base end portion of the fork 311, it may be expressed as a base end portion support member. In the present embodiment, the supporting portion 3131a is a plate-shaped member having a predetermined width in one direction, and is supported from below so as to overlap the base end portion (one end portion) of the fork 311 when viewed from a vertical direction.

Note that as described above, since the carry-in/out mechanism 31 is rotatable by the rotation mechanism 324, the fork 311 is movable in an arbitrary horizontal direction, and the advancing/retracting of the fork 311 herein corresponds to the pull-out and storage of the fork 311 (see FIGS. 10A and 10B).

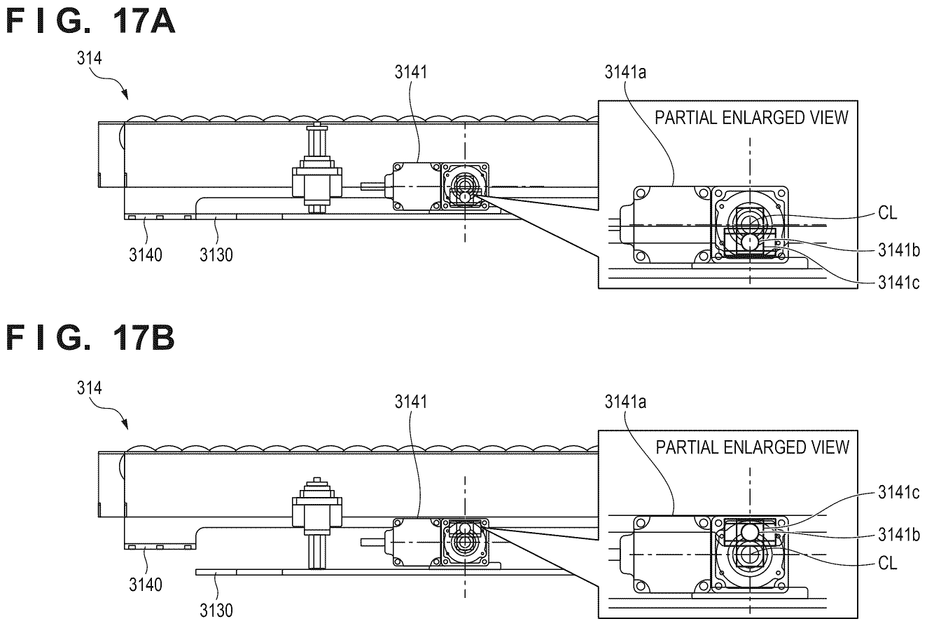

FIGS. 17A and 17B are side views illustrating a detailed structure of the conveyor lifting/lowering mechanism 314. FIG. 17A illustrates a state when the conveyor 312 is lowered, and FIG. 17B illustrates a state when the conveyor 312 is lifted. Hereinafter, description will be made with reference to FIGS. 11, 17A, and 17B.

The guide member 3143 is provided on the support plate member 3130. The support plate members 3142a and 3142b are supported by a plurality of guide members 3143 which guide the support plate members 3142a and 3142b so as to be able to be lifted/lowered. The support plate member 3142c is arranged between the support plate members 3142a and 3142b, and the support plate members 3142a to 3142c are connected to the connection plate member 3140.

That is, the support plate members 3142a to 3142c and the connection plate member 3140 are supported so as to be able to be lifted/lowered with respect to the support plate member 3130. In the present embodiment, the connection plate member 3140 forms the horizontal plane together with the support plate member 3130, but is not limited thereto, and may have any position and shape as long as the position and shape do not interfere with the advancing/retracting operation of the fork 311 by the fork advancement/retraction mechanism 313 described above. A pair of drive portions 3141 are provided, and each of the drive portions is connected (engaged) with the support plate members 3142a and 3142b.

The drive portion 3141 includes a power source 3141a which has a rotation shaft and generates power, a cam member 3141b which is provided on the rotation shaft, and a cam groove member 3141c which is provided on each of the support plate members 3142a and 3142b and is engaged with the cam member 3141b. In the present embodiment, the cam member 3141b is provided eccentrically from a center CL of the rotation shaft, and the cam groove member 3141c has a cam groove which is engaged with the cam member 3141b and extends in the horizontal direction. Therefore, when the cam member 3141b is rotated by the drive portion 3141, the cam groove member 3141c is lifted/lowered, and accordingly, the support plate members 3142a and 3142b on which the cam groove member 3141c is installed are lifted/lowered. In addition, as the support plate members 3142a and 3142b are lifted/lowered, the support plate member 3142c connected by the connection plate member 3140 is also lifted/lowered.

The support plate members 3142a, 3142b, and 3142c rotatably support the plurality of conveyance rollers 312a, 312b, and 312c, respectively. In the present embodiment, a cam mechanism is used for the drive portion, but the present invention is not limited thereto, and for example, a cylinder or the like may be used for the drive portion.

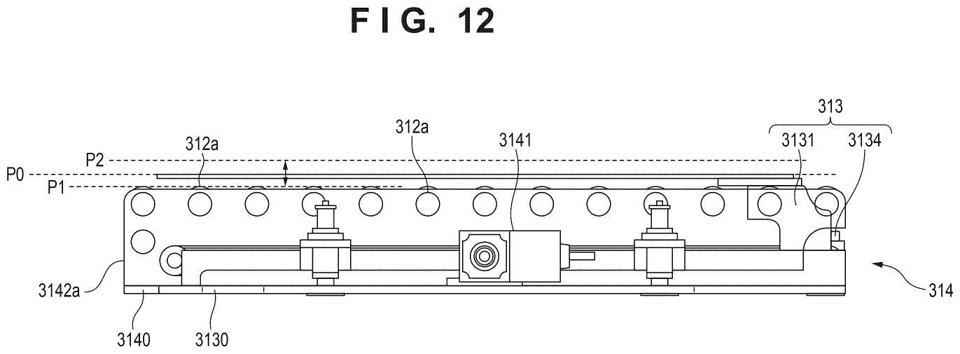

FIG. 12 is a side view illustrating a detailed structure of the carry-in/out mechanism 31. As described above, the support plate members 3142a, 3142b, and 3142c supporting the plurality of conveyance rollers 312a, 312b, and 312c can be lifted/lowered with respect to the support plate member 3130 on the basis of the power of the drive portion 3141. That is, the conveyor 312 can be lifted/lowered with respect to the support plate member 3130 on the basis of the power of the drive portion 3141. Here, the fork advancement/retraction mechanism 313 performs only the advancing/retracting operation of the fork 311, and the fork 311 does not perform a lifting/lowering operation with respect to the support plate member 3130. Therefore, the conveyance surface of the conveyor 312 is movable between a first position P1 below a position P0 of the upper surface of the fork 311 (the support surface which supports the substrate SB) and a second position P2 above the position P0.

For example, the substrate SB on the fork 311 is transferred from the fork 311 to the conveyor 312 in a case where the conveyor 312 is lifted from the position P1 to the position P2. In addition, the substrate SB on the conveyor 312 at the position P2 is transferred from the conveyor 312 to the fork 311 in a case where the conveyor 312 is lowered from the position P2 to the position P1. That is, when the conveyor lifting/lowering mechanism 314 lifts/lowers the conveyor 312, the substrate SB is transferred between the fork 311 and the conveyor 312.

The conveyor lifting/lowering mechanism 314 may be simply expressed as a lifting/lowering mechanism.

According to such a configuration, the transfer of the substrate SB between the fork 311 and the conveyor 312 is performed by lifting/lowering the conveyor 312 with respect to the fork 311, and the fork 311 performs only the advancing/retracting operation by the fork advancement/retraction mechanism 313. At the time of transferring the substrate SB between the fork 311 and the conveyor 312, particularly at the time of transferring the substrate SB from the conveyor 312 to the fork 311, the fork 311 remains stationary in order to cause the fork 311 to support the substrate SB as the conveyor 312 is lowered. Therefore, the magnitude of the vibration generated in the fork 311 at the time of transferring the substrate SB can be reduced, a standby time until the vibration affecting the start of the advancing operation of the fork 311 is settled is shortened, and the carry-in/out efficiency and the transport efficiency of the substrate SB can be improved.

Note that a power line and a signal line (not illustrated) connected to each power source exemplified in the present embodiment may be arranged so as to be able to allow movement such as reciprocation and advancing/retracting of the corresponding element, and are arranged while being held by, for example, a cable carrier or the like.

### Regarding Carry-In/Out Mode of Substrate

Carry-in/out of the substrate SB by the carry-in/out mechanism 31 is performed by advancing/retracting the fork 311 by the fork advancement/retraction mechanism 313 (see FIGS. 10A and 10B), and at that time, the advancing/retracting by the front-back moving mechanism 322 may accompany the process in order to further bring the substrate SB close to the container body 700.

In addition, carry-in/out of the substrate SB can also be realized by the conveyance of the conveyor 312, and at that time, the advancing/retracting by the front-back moving mechanism 322 may accompany the process. For example, although not illustrated in the present embodiment, it is conceivable that the carry-in/out mechanism 31 transfers the substrate SB to another work unit including a predetermined substrate reception portion. In such a case, the carry-in/out mechanism 31 can bring the fork 311 and the conveyor 312 close to the substrate reception portion of the other work unit by the front-back moving mechanism 322, and carry the substrate SB out to the other work unit by the conveyance of the conveyor 312.

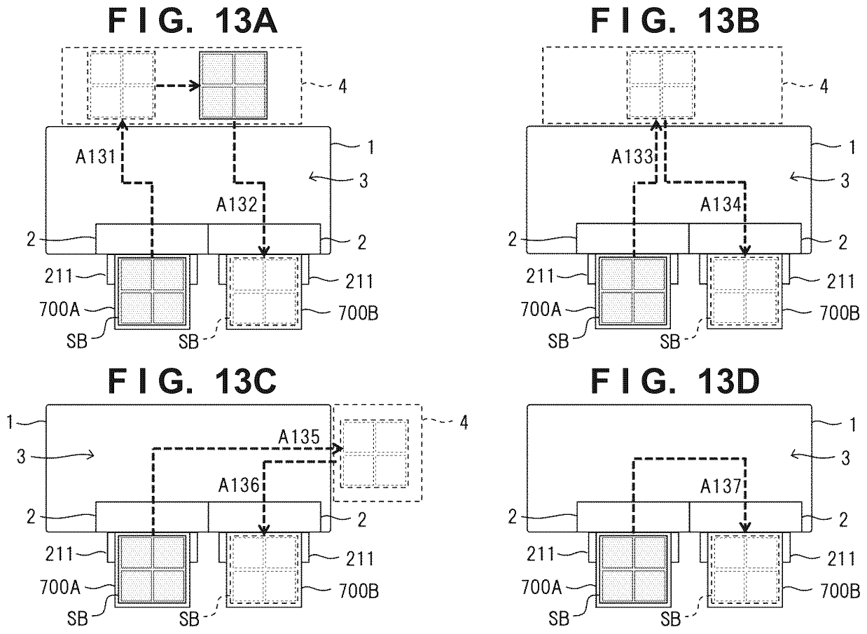

FIGS. 13A to 13D are schematic top views illustrating some examples of modes of carry-in/out or conveyance of the substrate SB.

In the example of FIG. 13A, it is assumed that a work unit 4 which performs a predetermined work (for example, a cleaning work) on the substrate SB is arranged on the back side of the work apparatus 1 as the other work unit. In the case of this example, another carry-in/out port may be provided on the back side of the work apparatus 1, and another storage container supply mechanism 2 may be added as necessary.

According to the configuration of the conveyance work unit 3 of the present embodiment, as described above, the carry-in/out mechanism 31 is movable in any of the X, Y, and Z directions, and the posture thereof can be changed by rotation. Therefore, the substrate SB taken out from a container body 700A via the work apparatus 1 is carried out to the other work unit 4 via the path of an arrow A131, and after the work is performed in the work unit 4, the substrate SB can be stored in another container body 700B via the work apparatus 1 in a path different from the arrow A131 (see an arrow A132). Thus, according to the present embodiment, the substrate SB can be managed separately before and after the work by the work unit 4.

Note that the carry-out of the substrate SB during this example (the carry-out to the work unit 4 and the carry-out to the container body 700B) may be performed by the advancing/retracting of the fork 311, may be performed by the conveyance of the conveyor 312, or may be performed by a combination thereof.

In the example of FIG. 13B, it is assumed that the carry-out of the substrate SB to the work unit 4 and the carry-in of the substrate SB from the work unit 4 are performed at the same position. According to the configuration of the present embodiment, the substrate SB taken out from the container body 700A and carried out to the work unit 4 (see an arrow A133) can be stored in the other container body 700B after the work is performed by the work unit 4 (see an arrow A134).

In the example of FIG. 13C, it is assumed that the work unit 4 is arranged on the side surface side of the work apparatus 1. In the case of this example, another carry-in/out port may be provided on the side surface side of the work apparatus 1, and another storage container supply mechanism 2 may be added as necessary. According to the configuration of the present embodiment, the substrate SB taken out from the container body 700A and carried out to the work unit 4 (see an arrow A135) can be stored in the other container body 700B after the work is performed by the work unit 4 (see an arrow A136).

In the example of FIG. 13D, it is assumed that the substrate SB is simply transferred from the container body 700A to the container body 700B without any work by the work unit 4. According to the configuration of the present embodiment, the substrate SB taken out from the container body 700A can be stored in the other container body 700B as it is (see an arrow A137).

Note that even in any case of FIGS. 13B to 13D, similarly to FIG. 13A, the carry-out of the substrate SB may be performed by the advancing/retracting of the fork 311, may be performed by the conveyance of the conveyor 312, or may be performed by a combination thereof.

As described above, according to the configuration of the present embodiment, the substrate SB can be carried in/out or conveyed in various modes, and the arrangement mode of the work unit 4 can be diversified. Thus, according to the present embodiment, it can be said that it is also advantageous for diversification of work content.

### Second Embodiment

In the first embodiment described above, an example of the configuration of the conveyance work unit 3 in which the carry-in/out mechanism 31 can be moved in any of the X, Y, and Z directions and the posture thereof can be changed by rotation has been described, but the configuration is not limited thereto.

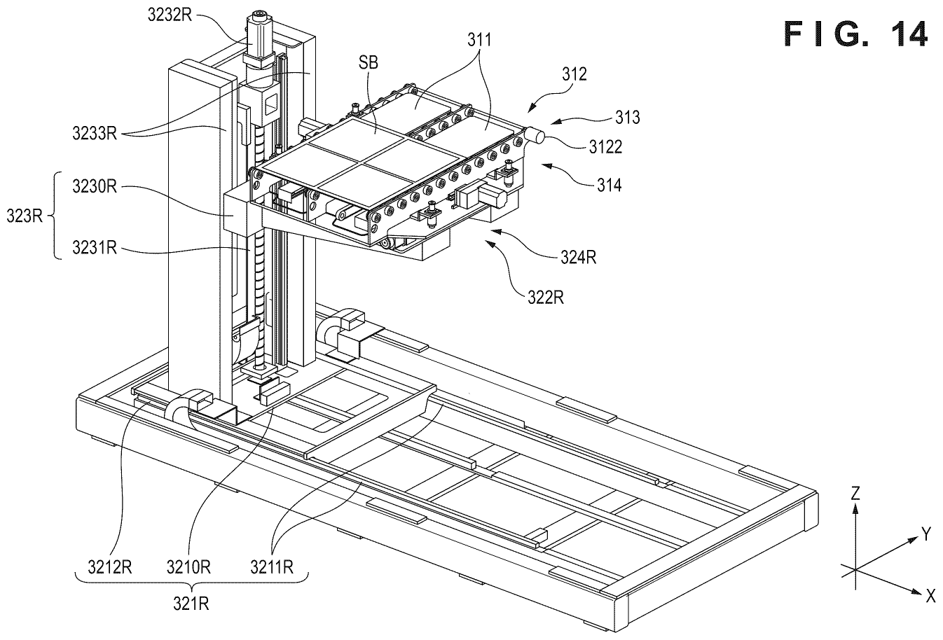

FIG. 14 is a perspective view in which the exterior panel 10 of the conveyance work unit 3 according to a second embodiment is not illustrated. In the present embodiment, the conveyance work unit 3 includes a right-left moving mechanism 321R, a front-back moving mechanism 322R, an up-down moving mechanism 323R, and a rotation mechanism 324R in addition to the carry-in/out mechanism 31. Each of the mechanisms 321R to 324R is configured to be able to realize the same function as each of the mechanisms 321 to 324 described above, and is distinguished by adding “R” to the end of a reference number here (the same applies to individual elements, such as a support plate member 3230R, included in the mechanisms 321R to 324R).

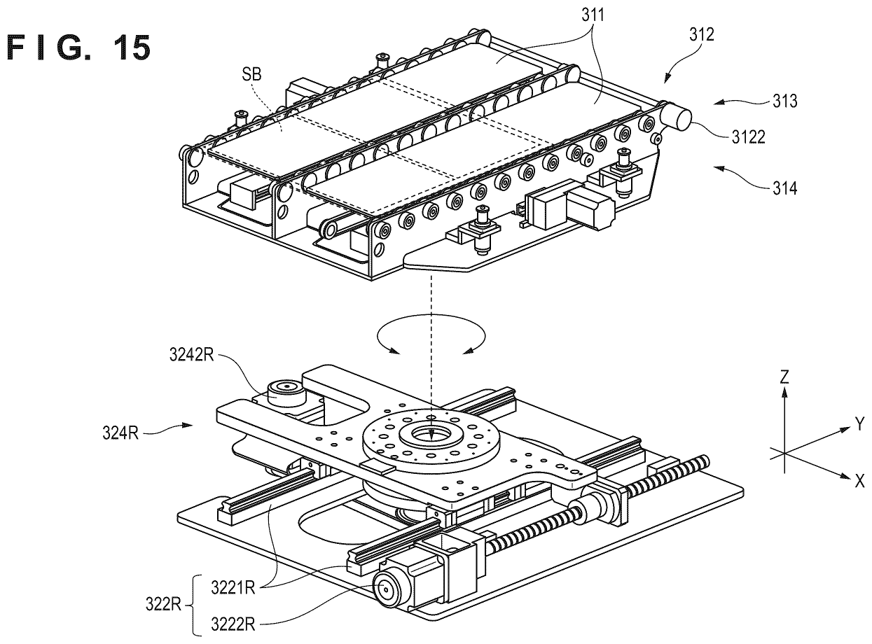

FIG. 15 illustrates a structure in which the carry-in/out mechanism 31 is separated from the front-back moving mechanism 322R and the rotation mechanism 324R.

In the structure of the present embodiment, the carry-in/out mechanism 31 is rotatably supported by the rotation mechanism 324R, the rotation mechanism 324R is mounted on the front-back moving mechanism 322R so as to be able to advance/retract, the front-back moving mechanism 322R is supported on the up-down moving mechanism 323R so as to be able to be lifted/lowered, and the up-down moving mechanism 323R is mounted on the right-left moving mechanism 321R so as to be able to reciprocate.

The structure of the present embodiment is different from that of the first embodiment described above in that the rotation mechanism 324R is mounted on the front-back moving mechanism 322R so as to be able to advance/retract, the front-back moving mechanism 322R is supported on the up-down moving mechanism 323R so as to be able to be lifted/lowered, and the up-down moving mechanism 323R is mounted on the right-left moving mechanism 321R so as to be able to reciprocate.

In addition, in the present embodiment, the configuration of the up-down moving mechanism 323R is different from that of the first embodiment described above. In the present embodiment, in the up-down moving mechanism 323R, the support plate member 3230R is provided in a lifting/lowering guide member 3233R extending in the Z direction side by side with a ball screw shaft 3231R so as to be movable along the lifting/lowering guide member 3233R, so that the carry-in/out mechanism 31 can be lifted/lowered. Then, the up-down moving mechanism 323R is configured in a columnar shape and arranged on the −X side of the carry-in/out mechanism 31, that is, is not arranged on the +X side of the carry-in/out mechanism 31. Therefore, the carry-in/out mechanism 31 can carry in/out the substrate SB on the side (that is, the +X side) opposite to the side of the up-down moving mechanism 323R. According to such a configuration, it is possible to realize carry-in/out of the substrate SB also in the example of FIG. 13C. According to the configuration of the present embodiment, it is possible to perform carry-in/out work to a lower position as compared with the first embodiment described above.

### Program

As described above, the program that the control unit 9 causes the CPU to execute in controlling the entire system of the work apparatus 1 may be stored as a computer program in a computer-readable storage medium. Alternatively, a computer program product that, when executed by the processor, implements the same function may be mounted on the work apparatus 1.

### Others

In the above description, each element is indicated by a name related to its function for facilitating understanding, but each element is not limited to the one having the content described in the embodiment as a main function, and may be the one having the content as an auxiliary function.

In the above description, each element is indicated by a name related to its function for facilitating understanding, but each element is not limited to the one having the content described in the embodiment as a main function, and may be the one having the content as an auxiliary function. Thus, each element is not strictly limited to the corresponding expression, and the expression can be replaced with another equivalent expression.

For the same purpose, the expressions “apparatus”, “unit”, “mechanism”, “member”, “portion”, “component, piece”, “structure”, “assembly”, “means” and the like can be replaced with each other or omitted.

In addition, two or more elements having similar functions may be distinguished by adding expressions such as “first” and “second”, but these expressions are not intended to set priorities, and the order thereof may be interchangeable. For example, the X direction may be a first direction and the Y direction may be a second direction, or the Y direction may be the first direction and the X direction may be the second direction (the same applies to the Z direction).

In addition, two or more elements selectively illustrated in the embodiments are not strictly limited to the illustration thereof, and may be arbitrarily combined. For example, each of the two or more illustrated elements may be additionally or alternatively selected. As an example, in a case where two elements of A and B can be arbitrarily combined, the expression “A and/or B” or the expression “at least one of A or B” may be used to indicate any one of A only, B only, or both A and B.

The invention is not limited to the foregoing embodiments, and various variations/changes are possible within the spirit of the invention.

What is claimed is:

1. A work apparatus comprising: a carry-in/out mechanism for performing carry-in/out of a substrate; and a moving mechanism for moving the carry-in/out mechanism, wherein
the carry-in/out mechanism includes
a substrate support member which extends in a carry-in/out direction so as to be able to support the substrate,
an advancement/retraction mechanism configured to advance/retract the substrate support member in the carry-in/out direction,
a substrate conveyance mechanism capable of conveying the substrate in the carry-in/out direction, and
a lifting/lowering mechanism configured to lift/lower the substrate conveyance mechanism,
the advancement/retraction mechanism includes
a base end portion support member configured to support a base end portion of the substrate support member, and
a drive portion configured to move the base end portion support member in the carry-in/out direction,
the base end portion is provided at an end portion on one side in the carry-in/out direction of the substrate support member, and
the substrate is transferred between the substrate support member and the substrate conveyance mechanism by the lifting/lowering mechanism lifting/lowering the substrate conveyance mechanism.

2. The work apparatus according to claim 1, wherein
the lifting/lowering mechanism lifts/lowers the substrate conveyance mechanism between
a first position at which a conveyance surface of the substrate conveyance mechanism for the substrate is below a support surface of the substrate support member for the substrate, and
a second position at which the conveyance surface is above the support surface.

3. The work apparatus according to claim 2, wherein
the lifting/lowering mechanism performs
an operation of transferring the substrate from the substrate support member to the substrate conveyance mechanism by lifting the substrate conveyance mechanism from the first position to the second position, and
an operation of transferring the substrate from the substrate conveyance mechanism to the substrate support member by lowering the substrate conveyance mechanism from the second position to the first position.

4. The work apparatus according to claim 1, wherein
the moving mechanism includes
a first moving mechanism configured to move the carry-in/out mechanism in a first direction orthogonal to the carry-in/out direction, and
a carry-in/out mechanism lifting/lowering mechanism configured to lift/lower the carry-in/out mechanism.

5. The work apparatus according to claim 4, wherein
the moving mechanism further includes a second moving mechanism configured to move the carry-in/out mechanism in a second direction orthogonal to the first direction.

6. The work apparatus according to claim 5, wherein
the moving mechanism moves the carry-in/out mechanism such that one end portion of the substrate conveyance mechanism approaches or separates from a predetermined substrate reception portion capable of receiving the substrate.

7. The work apparatus according to claim 4, wherein
the moving mechanism further includes a carry-in/out mechanism rotation mechanism configured to rotate the carry-in/out mechanism about an up-down direction as a central axis.

8. The work apparatus according to claim 1, wherein
the moving mechanism includes
a first moving mechanism configured to move the carry-in/out mechanism in a first direction orthogonal to the carry-in/out direction,
a second moving mechanism configured to move the carry-in/out mechanism in a second direction orthogonal to the first direction,
a carry-in/out mechanism lifting/lowering mechanism configured to lift/lower the carry-in/out mechanism, and
a carry-in/out mechanism rotation mechanism configured to rotate the carry-in/out mechanism about an up-down direction as a central axis,
the second moving mechanism and the carry-in/out mechanism rotation mechanism are installed on the carry-in/out mechanism lifting/lowering mechanism, and
the carry-in/out mechanism lifting/lowering mechanism is installed on the first moving mechanism.

9. The work apparatus according to claim 4, wherein
the carry-in/out mechanism lifting/lowering mechanism includes
a support column which extends in an up-down direction and is configured to support the carry-in/out mechanism from below, and
a second drive portion configured to lift/lower the support column.

10. The work apparatus according to claim 4, wherein
the carry-in/out mechanism lifting/lowering mechanism includes
a lifting/lowering guide member which extends in an up-down direction,
a lifting/lowering support portion which is provided on one side in the first direction of the lifting/lowering guide member so as to be able to be lifted/lowered along the lifting/lowering guide member and is configured to support the carry-in/out mechanism, and
a third drive portion configured to lift/lower the lifting/lowering support portion, and
the carry-in/out mechanism performs the carry-in/out on a side opposite to a side of the lifting/lowering guide member.

11. The work apparatus according to claim 1, wherein
the substrate conveyance mechanism includes a first conveyance roller portion, a second conveyance roller portion, and a third conveyance roller portion which are arranged side by side to be separated in a direction orthogonal to the carry-in/out direction,
the third conveyance roller portion is arranged between the first conveyance roller portion and the second conveyance roller portion,
the substrate support member includes
a first plate-shaped member which is arranged between the first conveyance roller portion and the third conveyance roller portion, and
a second plate-shaped member which is arranged between the second conveyance roller portion and the third conveyance roller portion,
the base end portion support member includes
a first support member which supports a base end portion of the first plate-shaped member, and
a second support member which supports a base end portion of the second plate-shaped member, and
the drive portion generates power for moving the first support member and the second support member in the carry-in/out direction.

12. The work apparatus according to claim 1, further comprising:
an apparatus housing configured to store the carry-in/out mechanism and the moving mechanism, wherein
the apparatus housing is provided with a first carry-in/out port and a second carry-in/out port for performing the carry-in/out, and
the carry-in/out mechanism
performs, at the first carry-in/out port, one of the carry-in/out by using the substrate support member and the advancement/retraction mechanism, and
performs, at the second carry-in/out port, another of the carry-in/out by using the substrate conveyance mechanism and the lifting/lowering mechanism.

13. A carry-in/out apparatus configured to transport a substrate from one side to another side in a carry-in/out direction in which the substrate is carried in/out, the carry-in/out apparatus comprising:
a substrate support member which extends in the carry-in/out direction so as to be able to support the substrate;
an advancement/retraction mechanism configured to advance/retract the substrate support member in the carry-in/out direction;
a substrate conveyance mechanism capable of conveying the substrate to the other side in the carry-in/out direction; and
a lifting/lowering mechanism configured to lift/lower the substrate conveyance mechanism, wherein
the advancement/retraction mechanism includes
a base end portion support member configured to support a base end portion of the substrate support member, and
a drive portion configured to move the base end portion support member in the carry-in/out direction,
the base end portion is provided at an end portion on the other side in the carry-in/out direction of the base end portion support member, and
the lifting/lowering mechanism lifts/lowers the substrate conveyance mechanism between
a first position at which a conveyance surface of the substrate conveyance mechanism for the substrate is below a support surface of the substrate support member for the substrate, and
a second position at which the conveyance surface is above the support surface.
